(19) United States
(12) Patent Application Publication
(10) Pub. No.: US 2024/0249457 A1
(43) Pub. Date: Jul. 25, 2024

(54) SYSTEM AND METHOD TO GENERATING VIDEO BY TEXT

(71) Applicant: Idomoo LTD, Raanana (IL)

(72) Inventors: Danny KALISH, Raanana (IL); Dan SHAMIR, Raanana (IL)

(21) Appl. No.: 18/418,501

(22) Filed: Jan. 22, 2024

Related U.S. Application Data
(60) Provisional application No. 63/480,714, filed on Jan. 20, 2023.

(51) Int. Cl. G06T 13/00; G06F 40/20; G06T 11/60

(52) U.S. Cl. CPC G06T 13/00; G06F 40/20; G06T 11/60; G06T 2200/24

(57) ABSTRACT

The present invention discloses a method for generating video, to perform the steps of:
receive entity instructions by text or voice using natural language;
analyzing entity instructions for identifying technical and creative requirements including: style, context, content, type and properties of content objects, layout of video frames, order—sequence of disapplying content, functionality of objects;
selecting video template of at least one scene based analysed instructions and all identified technical and creative requirements;
exploring and aggregating content of text, image or video multimedia based on identified technical and creative requirements of the selected at least one template;
generating new video by implementing selected or new video template using aggregated content wherein the generated video complies with all analyzed requirements.

### BACKGROUND

### Technical Field

The present invention relates generally to automatic generation of video to by text.

### SUMMARY

The present invention discloses a method for generating video, said method comprising the steps of:
receive user instructions by text or voice using natural language.
analyzing user instructions, identifying technical requirements (where to display, time format), required, style, context and/or content, number, type and properties of content objects, layout of video frames, order—sequence of disapplying content, functionality of objects, optionally object customization option;
selecting video template based analysed instructions or generating new video template
exploring and aggregating content of text, image or video multimedia based on identified requirements;
creating scenes, optionally generating new content using inter or external graphic multimedia tools
Generating new video by implementing selected or new video template using aggregating content wherein the generated video complies with all analyzed requirements;
According to some embodiments the method according to the present invention further comprising the steps of:
   Generating multiple videos which implement selected or new video template using aggregating content wherein the generated video complies with all analyzed requirements, wherein each video may use different template or using different content or properties of objects;
Enabling user select one of the videos, saving users history choice
   Learning personalized user preferences;
   Ai learning plurality of user's choice, training video editing rules
The present invention discloses a method for generating video, implemented by one or more processors operatively coupled to a non-transitory computer readable storage device, on which are stored modules of instruction code that when executed cause the one or more processors to perform the steps of:
   receive entity instructions by text or voice using natural language;
   analyzing entity instructions for identifying technical and creative requirements including: style, context and/or content, type and properties of content objects, layout of video frames, order—sequence of disapplying content and/or functionality of objects;
   selecting at least one video template of at least one scene based analysed instructions and all identified technical and creative requirements;
   exploring and aggregating content of text, image or video multimedia based on identified technical and creative requirements of the selected at least one template;
      generating new video by implementing selected or new video template using aggregated content wherein the generated video complies with all analyzed requirements;
According to some embodiments of the present invention the method further comprising the steps of:
   Generating multiple videos which implement selected or new video template using aggregating content wherein the generated video complies with all analyzed requirements, wherein each video use different template or using different content or properties of objects;
enabling entity to select one of the videos, saving entity history choice
   learning personalized entity preferences;
   creating Ai model by learning plurality of user's choice, training video editing rules
According to some embodiments of the present invention the method further comprising the step of: exploring and aggregating content from different internal and/or external sources content of text, image or video multimedia based on identified technical and creative requirements.
According to some embodiments of the present invention all scene media parts are customized and personalized based entity branding/profile data, the branding can be provided by the entity.
According to some embodiments of the present invention the method further comprising the step of: entity entering more instruction/editing previous instruction, wherein the entity can select manually more relevant media or use services entity can upload his own media or text Entity can delete scenes, update the script,
According to some embodiments of the present invention the method further comprising the step of: enabling entity to approve final version and enabling manual editing of the video.
According to some embodiments of the present invention the method further comprising the step of: determining script and style, length of video by a designated
AI model based on entity text using external AI system and entity/company profile and branding.
According to some embodiments of the present invention the method further comprising the step of: defining scenario parts/scene based on created determined script.
According to some embodiments of the present invention the method further comprising the step of: selecting multiple block template of different scenes.
According to some embodiments of the present invention the method further comprising the step of: generating content using designated AI model by determining context and/or content, emotion, theme number, type and properties of content objects, layout of video frames, order, sequence of disapplying content, functionality of objects.
According to some embodiments of the present invention the method the entity or entity defines length of video wherein the defined length affects the selection of subjects based on priority, the focus in each subject and selection content for each subject to meet the time limit.
According to some embodiments of the present invention the method the function of the object is call to action including: hyperlink of communication network, payment or purchase button.
The present invention disclose a system for generating video, implemented by one or more processors operatively coupled to a non-transitory computer readable storage device, on which are stored modules processors to perform the steps of:
   user interfaces module configured to receive user or entity instructions by text or voice using natural language;
   video generation server configures for:
      analyzing entity instructions for identifying technical and creative requirements including: style, context and/or content, type and properties of content objects, layout of video frames, order sequence of disapplying content, functionality of objects;
      selecting at least one video template of at least one scene based analysed instructions and all identified technical and creative requirements;
      exploring and aggregating content of text, image or video multimedia based on identified technical and creative requirements of the selected at least one template;
         Generating new video by implementing selected or new video template using aggregated content wherein the generated video complies with all analyzed requirements;
According to some embodiments of the present invention the system he video generation server the further configured to explore and aggregate content from different internal and/or external sources content of text, image or video multimedia based on identified technical and creative requirements.
According to some embodiments of the present invention the system all scene media parts are customized and personalized based entity or entity branding/profile data, the branding can be provided by entity or by smart analyzing any entity content.
According to some embodiments of the present invention the system the user interface module is further configured to enable entity entering more instruction/editing previous instruction, enabling to select manually more relevant media or use external services enabling to upload media or text or delete scenes or update the script.
According to some embodiments of the present invention the system the user interface module is further configured user approving final version and enabling manual editing option.
According to some embodiments of the present invention the system where the video generation server the further configured to determine script or story board, define style by a designated AI model based on user text using external AI system and user/company profile and branding.
According to some embodiments of the present invention the video generation server the further configured to define scenario parts or scene based on created determined script or user text.
According to some embodiments of the present invention the video generation server the further configured to select multiple block template of different scene.
According to some embodiments of the present invention user or entity defines length of video, wherein the defined length affects the selection of subjects based on priority, the focus in each subject and selection content for each subject to meet the time limit.
According to some embodiments of the present invention the function of the object is call to action including: hyperlink of communication network, payment or purchase button.

### BRIEF DESCRIPTION OF THE SCHEMATICS

The present invention will be more readily understood from the detailed description of embodiments thereof made in conjunction with the accompanying drawings of which:

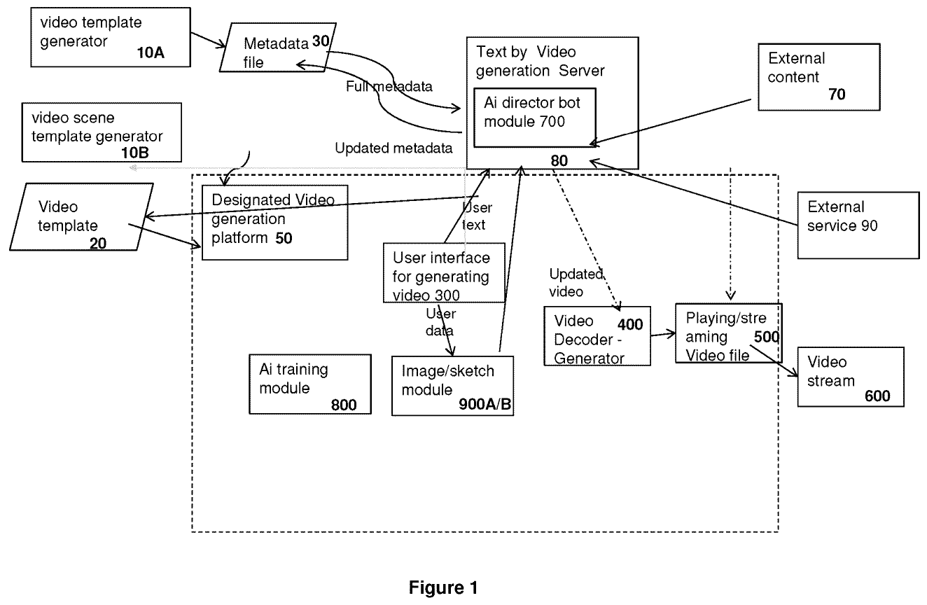

FIG. 1 is a block diagram, depicting the components and the environment of the video generation platform, according to some embodiments of the invention.

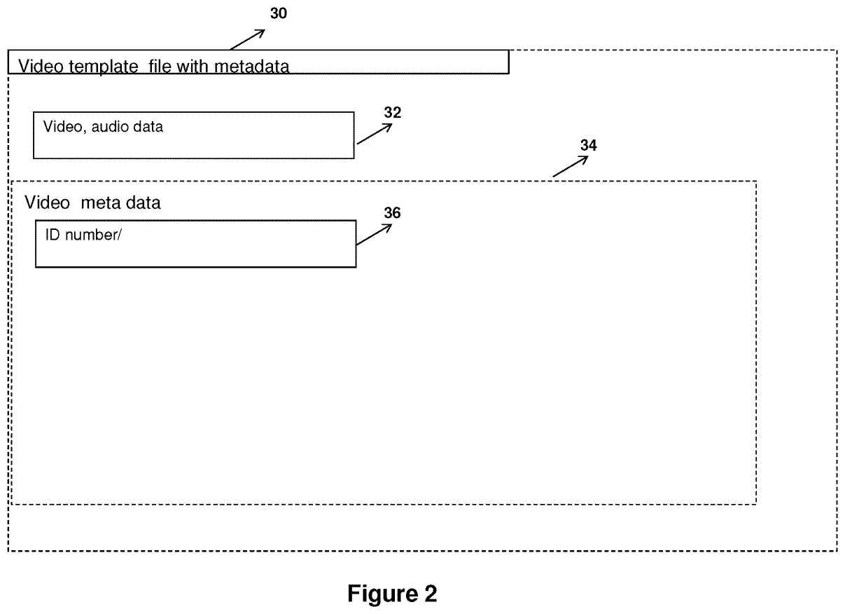

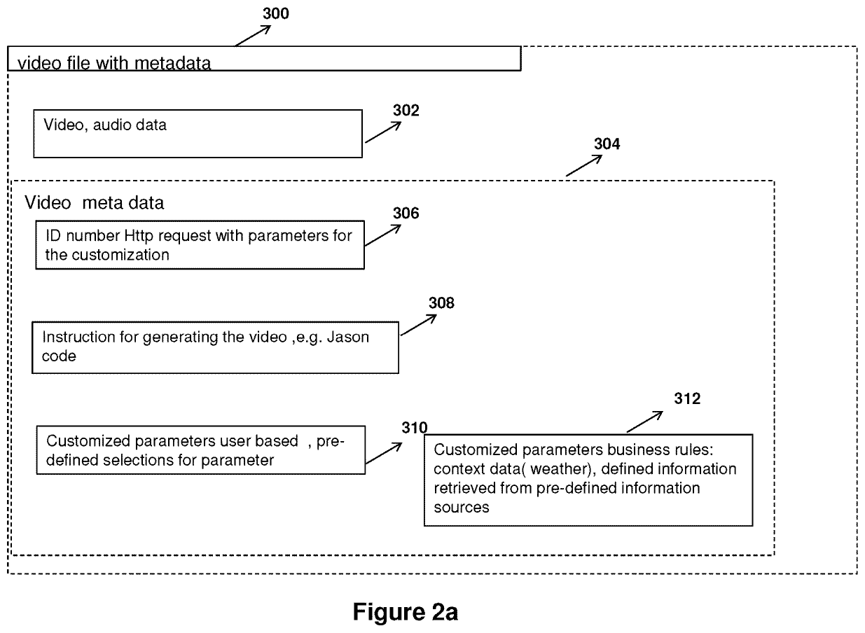

FIG. 2 is a block diagram depicting the video file format information structure, according to one embodiment of the invention.

FIG. 2A is a block diagram depicting the video file format information structure, according to one embodiment of the invention.

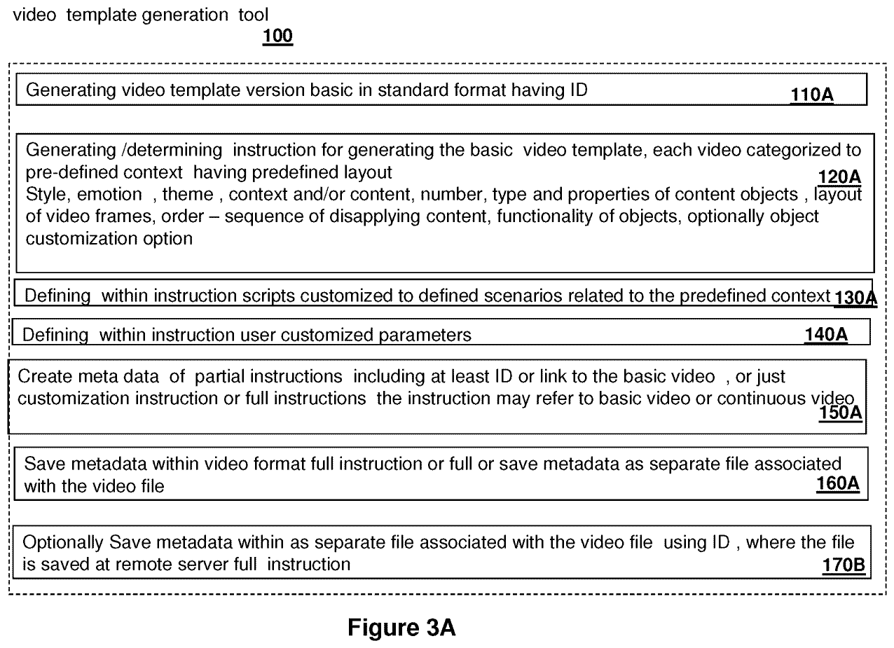

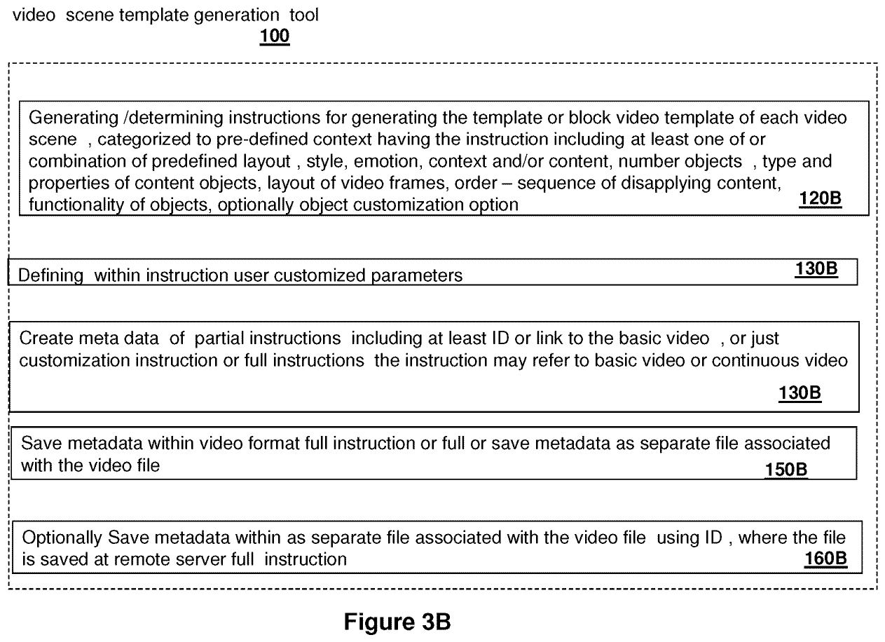

FIG. 3A is a flowchart depicting the video template generation module, according to some embodiments of the invention.

FIG. 3B is a flowchart depicting the video scene template generation module, according to some embodiments of the invention.

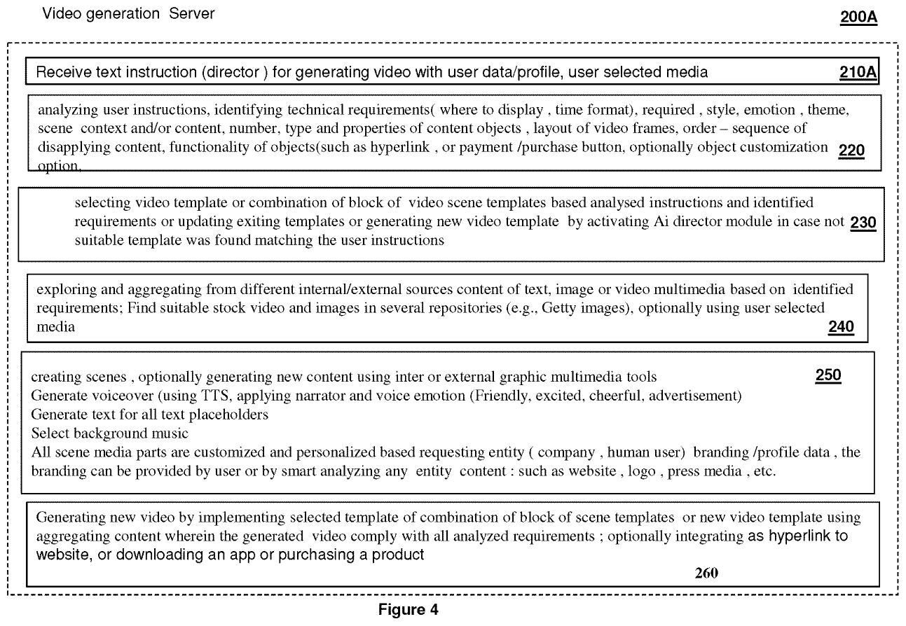

FIG. 4 is a flowchart depicting video generating by text server module according to some embodiments of the invention.

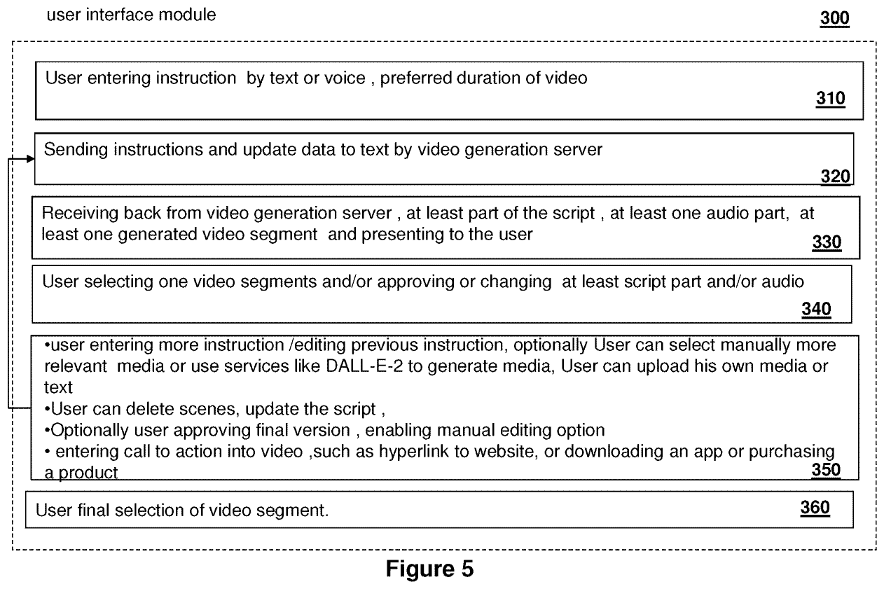

FIG. 5 presents a flowchart of the video user interface, according to some embodiments of the invention.

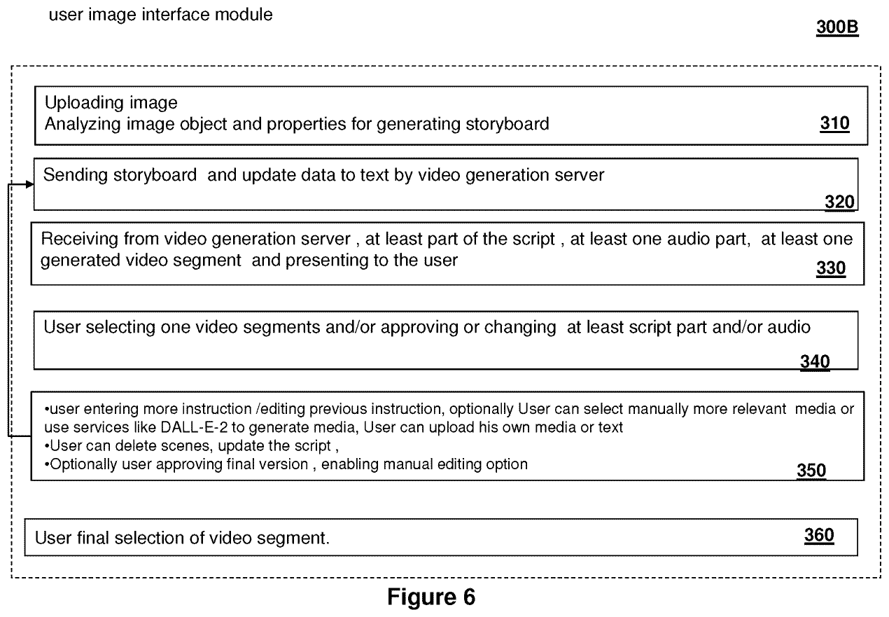

FIG. 6 presents a flowchart of the video interaction module, according to some embodiments of the invention.

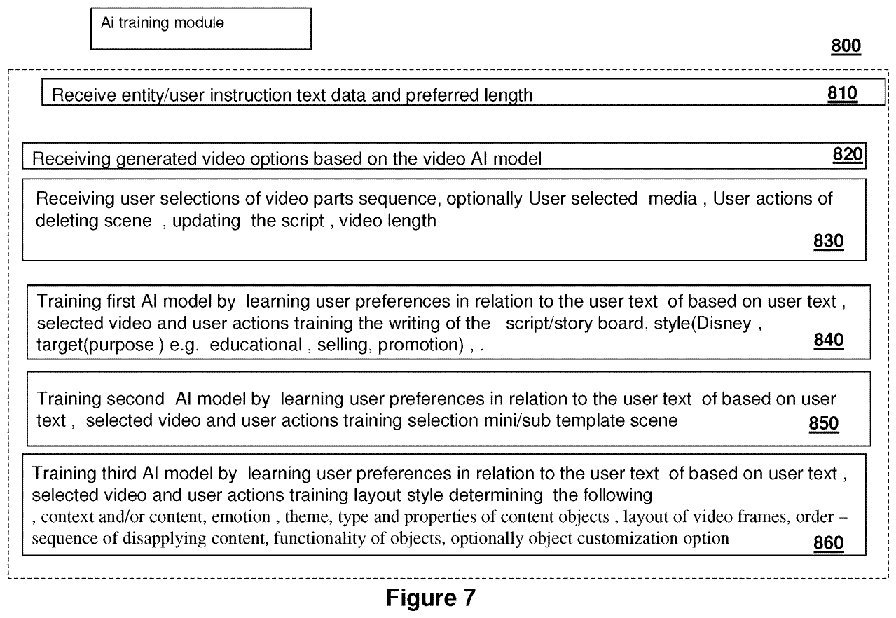

FIG. 7 presents a flowchart of the Ai video module, according to some embodiments of the invention.

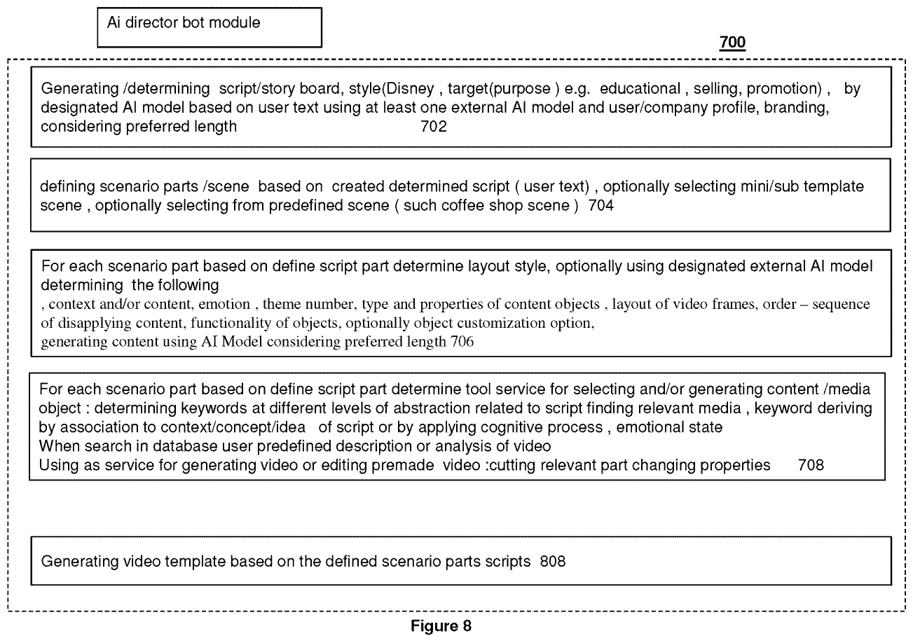

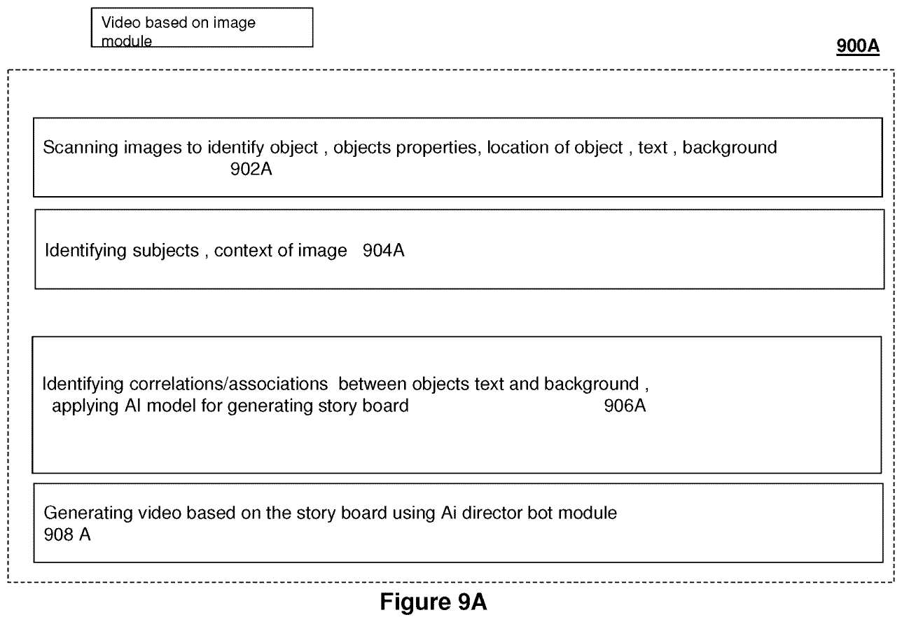

FIG. 8 presents a flowchart of the Ai director bot module, according to some embodiments of the invention.

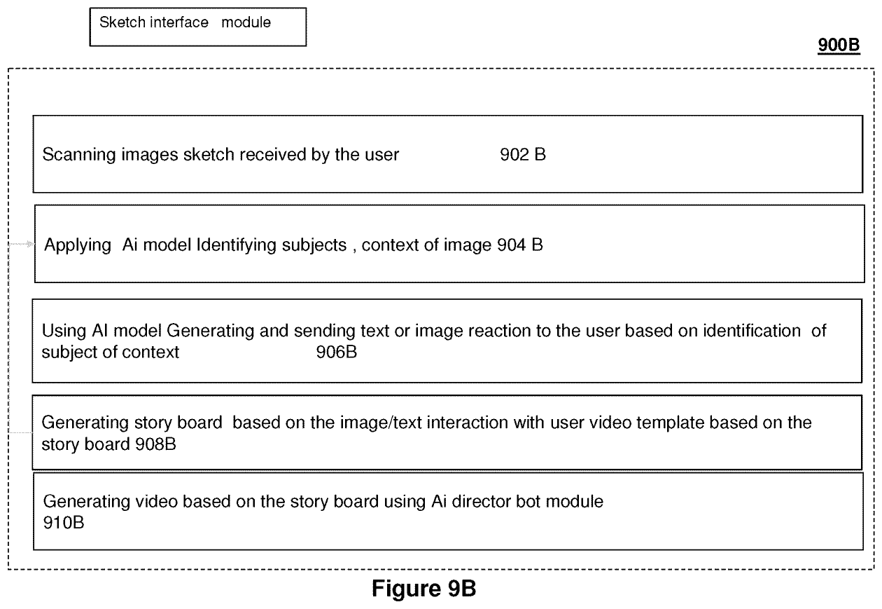

FIG. 9A presents a flowchart of the Video based on image module, according to some embodiments of the invention.

FIG. 9B presents a flowchart of the Sketch interface module, according to some embodiments of the invention.

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 1 is a block diagram, depicting the components and the environment of the video generation platform 50, according to some embodiments of the invention. The Designated Video generation platform 50 is comprised of: a user interface configured to receive entity/user to entered text and select between optional generated videos 300, interface module 900 configured for customizing the video by the user and text and video generation server 80 configured to receive entity/users' text, selection and customized data for generating relevant video parts based on pre-defined video templates or by using AI director module 700. The platform further comprises Video Decoder Generator 400, Playing/streaming Video file, 500 creating video stream 600, Ai training module 800, and Image/sketch module 900A/900B.

FIG. 2 is a block diagram depicting the video file format information structure, according to one embodiment of the invention.

According to this embodiment, the video file format of digital media container 30 is comprised of video or audio data 32 and meta data 34. The metadata comprises only video ID or a link to video 36, where metadata file is associated with the video ID or link.

FIG. 2A is a block diagram depicting the video file format information structure, according to one embodiment of the invention.

The video file format of digital media container 300 is comprised of video or audio data 302 and meta data 304. The meta data comprises at least video ID or a link 306 and/or optionally partial or full video generation instructions 308 and/or customized parameters 310. Optionally including Link to originating Video editor full project data 312.

FIG. 3A is a flowchart depicting the video template generation module, according to some embodiments of the invention.

The Video Template Generation Module is a sophisticated component designed for creating and managing video templates. It incorporates a series of steps, each contributing to the generation and customization of video templates.

Basic Video Generation (110A): The module begins by generating a basic version of the video in a standard format. Each basic video is assigned a unique identification number (ID), facilitating easy tracking and reference, 110A;
Generating/determining instruction for generating the basic video and/or continuous video, each video categorized to pre-defined context.
Instruction Generation/Determination (120): In this step, the module generates or determines instructions for creating both the basic video and any continuous videos. Each video is categorized into predefined contexts, ensuring relevance and appropriateness. These instructions encompass various aspects, such as predefined layouts, styles, emotional tones, contexts and content, the number of objects, types and properties of content objects, layouts of video frames, sequences of content display, object functionalities, and options for object customization; 120.
Defining within instruction scripts customized to defined scenarios related to the predefined context.

Script Definition for Scenarios (130A): Within these instructions, the module defines scripts that are customized to specific scenarios related to the predefined context. This step ensures that the video content is not only technically sound but also contextually relevant and engaging 130A;

Customized Parameter Definition: The module allows for the definition of user-customized parameters within the instructions. This customization ensures that the final video product aligns closely with the user's specific requirements and preferences.

Metadata Creation (140A): The module creates metadata for partial instructions, which includes at least the ID or a link to the basic video. It may also include customization instructions or full instructions. This metadata serves as a reference point, linking the instructions to either the basic or continuous videos 140A;

Metadata Storage (150A): The generated metadata is either saved within the full instruction set of the video format or stored as a separate file associated with the video file. This organization ensures easy retrieval and management of the metadata 150A;

Remote Storage Option (160A): Optionally, the metadata can be stored as a separate file on a remote server, associated with the video file using its ID. This option provides additional flexibility and security for storing and accessing video-related data 160A.

FIG. 3B is a flowchart depicting the video scene template generation tool, according to some embodiments of the invention.

The video template generation module applies at least one of the followings steps:
Generating video version basic in standard format having ID, 110B;
   Generating/determining instructions for generating the template or block video template of each video scene, categorized to pre-defined context having the instruction including at least one of or combination of predefined layout, style, emotion, context and/or content, number objects, type and properties of content objects, layout of video frames, order—sequence of disapplying content, functionality of objects, optionally object customization option, 120B.
Defining within instruction user customized parameters 130B;
Create meta data of partial instructions including at least ID or link to the basic video, or just customization instruction or full instructions the instruction may refer to basic video or continuous video 140B;
Save metadata within video format full instruction or full or save metadata as separate file associated with the video file 150B;
Optionally Save metadata within as separate file associated with the video file using ID, where the file is saved at remote server full instruction 160B.

FIG. 4 is a flowchart depicting video generating by text server module according to some embodiments of the invention.

The Text Server Module operates through a series of steps, each contributing to the video generation process:
Text Instruction Reception (210): The module starts by receiving text instructions for generating a video, along with entity/user data and profiles and optionally video length. This information forms the basis of the video creation process;
Instruction Analysis (220): The module analyzes the received instructions, focusing on identifying various technical and creative requirements. These include display specifications, time formats, video length, desired style, emotional tone, thematic elements, context and content, types and properties of content objects, layout of video frames, sequence of content display, object functionality, and options for object customization 220;
Template Selection and Customization (230): Based on the analyzed instructions and identified technical and creative requirements the module selects an appropriate video template or a combination of video scene templates. If existing templates are unsuitable, it updates them or generates new ones by activating the AI Director Module. This ensures a close match with the entity/user's instructions 230;
Content Aggregation (240): This step involves exploring and aggregating content from various internal and external sources. The content, which may include text, images, or video multimedia, is selected based on the identified requirements technical and creative from the previous analysis 240;
   Scene Creation and Content Generation: The module proceeds to create scenes, optionally using internal or external graphic multimedia tools to generate new content. This step ensures the video content is dynamic and engaging.
   Voiceover Generation: A voiceover is generated using text-to-speech technology. The module applies appropriate narrators and voice emotions (e.g., friendly, excited, cheerful, advertisement style) to align with the video's tone.
   Text Placeholder Filling: The module generates text for all text placeholders in the video, ensuring consistency and relevance to the video's content.
   Background Music Selection: Selecting suitable background music to complement the video's mood and enhance the viewer's experience.

Customization and Personalization (250): All scene media parts are customized and personalized based on the branding/profile data of the requesting entity (company or individual user). Branding elements can be provided by the user or determined through smart analysis of entity-related content, such as websites, logos, press media, etc. 250.

According to some embodiments of the present invention the defined length affects at least one of the following: Scene Creation and Content Generation, Template Selection, the selection of subjects based on priority, the generation of the script, the selection of media objects and/or the focus in each subject and selection content and media objects for each subject to meet the time limit.

Final Video Generation (260): The module generates the new video by implementing the selected template(s) or a newly created video template. The final video is tailored to comply with all analyzed technical and creative requirements, ensuring a product that meets the specific needs and preferences of the entity or user 260.

FIG. 5 presents a flowchart of the video user interface, according to some embodiments of the invention.

The User Interface Module operates through a series of steps, each designed to enhance user engagement and customization capabilities:

Instruction Input (310): Users or entities input their instructions via text or voice and define video length. This initial step allows users to convey their video creation requirements and preferences easily and intuitively 310;

Sending instructions to text by video generation server 320;

Script and Video Segment Reception (330): The user receives at least a part of the script, one or more audio parts, and one or more generated video segments. These elements are presented to the user for review and selection, providing a tangible representation of their initial instructions 330;

Video Segment Selection (340): The user or entity selects one of the presented video segments. This step allows for hands-on involvement in choosing the most suitable segment that aligns with their vision 340.

Further Instruction Input and Editing (350): The user can enter additional instructions or edit previous ones. They also have the option to manually select more relevant media or utilize services like DALL-E-2 for media generation. Users can upload their own media or text, delete scenes, update the script, and, if desired, approve the final version. This step also includes enabling manual editing options, allowing for greater customization and personalization of the video content 350.

Call to Action Insertion (Optional): Users have the option to insert a call to action into the video. This could be a hyperlink to a website, an invitation to download an app, or a prompt to purchase a product. This feature is particularly useful for marketing and promotional videos.

Final Video Segment Selection (360): The user or entity makes their final selection of the video segment. This concluding step ensures that the final video product aligns perfectly with the user's requirements and expectations, culminating in a fully customized and user-approved video content 360.

FIG. 6 presents a flowchart of the video interaction module, according to some embodiments of the invention.

The user video interaction module applies at least one of the following steps:
Uploading image by an entity or user;
Analyzing image objects and properties for generating storyboard 310B.
Sending storyboard and update data to text by video generation server 320B;
Receiving from video generation server, at least part of the script, at least one audio part, at least one generated video segment and presenting to the user 330B;
User/entity selecting one video segments and/or approving or changing at least script part and/or audio 340B.

User/entity entering more instruction/editing previous instruction, optionally User can select manually more relevant media or use services like DALL-E-2 to generate media, User can upload his own media or text.

Users can delete scenes, update the script, optionally user approving final version, enabling manual editing option 350B.

User final selection of video segment 360 B.

FIG. 7 showcases a flowchart of the AI Training Module, which is conceptualized in various embodiments of the invention. This module is designed to enhance the capability of AI in video production by learning from user interactions and preferences.

The AI Training Module operates through a sequence of steps, each step contributing to the overall machine learning process:

Text Data Reception (810): The module begins by receiving text data from users or entities. This data serves as the foundational input for the AI's learning process, providing context and content for subsequent video generation tasks.

Generated Video Options Reception (820): The module then receives a range of generated video options. These options are likely produced by an associated AI system and provide a variety of visual interpretations of the initial text data.

User Interaction Processing (830): At this stage, the module processes user selections regarding the sequence of video parts. It also incorporates any user-selected media, as well as user actions like deleting scenes or updating scripts. This step is crucial for understanding user preferences and tailoring the AI's output accordingly.

First AI Model Training (840): The first AI model is trained by learning from user preferences related to the initial user text. This includes preferences in the selection of video parts and user actions. The training focuses on script/storyboard writing, style adaptation (e.g., Disney style), target market determination, and purpose (such as educational, sales, or promotional content).

Second AI Model Training (850): The second AI model undergoes training based on user preferences, particularly focusing on the selection of mini/sub-template scenes. This training is tailored to user text, selected videos, and user actions, enhancing the AI's ability to choose appropriate scene templates that align with user preferences.

Third AI Model Training (860): The third AI model is trained to learn user preferences in various aspects: context and content based on user text, emotion and theme of the video, types and properties of content objects, layout of video frames, sequence of content display, functionality of objects, and options for object customization if available. This model's training is comprehensive, covering a wide range of elements crucial for producing a video that resonates with the user's intent and style.

FIG. 8 presents a flowchart of the Ai director bot module, according to some embodiments of the invention.

The Ai director bot module apply at least one of the followings steps:
Script/Storyboard/Style Generation: The module employs an external AI system (reference number 702) to generate or determine the script, storyboard, and visual style. This process is inherently adaptive, considering factors such as Disney-inspired styles, target markets (e.g., educational, sales, promotional), and the desired length of the video. The AI model derives this information from user-provided text, ensuring tailored output that aligns with the user's vision 702;
Scenario and Scene Definition: Based on the script derived from user input, the module (reference number 704) defines specific scenario parts or scenes. It selects block or sub-template scenes, with the option to choose from pre-defined scenes like a coffee shop setting. This step ensures each scene aligns cohesively with the overall script 704;
Scenario Part Customization: For each part of the scenario, as delineated in the script, the module (reference number 706) determines several key elements. These include the layout style, context, content, the number of objects, types and properties of content objects, and the layout of video frames. It also establishes the sequence for displaying content, the functionality of objects, and provides options for object customization. This is achieved using AI-driven processes, ensuring a rich and dynamic video composition 706;
Content and Media Object Selection: In this step, the module (reference number 708) determines the appropriate tool service for selecting or generating content and media objects. It involves determining keywords at various levels of abstraction related to the script, finding relevant media, and deriving keywords by association to the context, concepts, or ideas of the script. This may include applying cognitive processes or considering emotional states. The module can also search in a database using user-defined descriptions or analyses of the video. This facilitates the generation of new video content or the editing of pre-made videos, such as cutting relevant parts or changing properties to better suit the script.

According to some embodiments of the present invention the defined length affects at least one of the following: the selection of subjects based on priority, the generation of the script, the selection of media objects and/or the focus in each subject and selection content and media objects for each subject to meet the time limit.

FIG. 9A illustrates a flowchart of the ‘Video Based on Image’ Module, conceptualized in several embodiments of the invention. This module specializes in creating videos from static images using advanced AI techniques.

The ‘Video Based on Image’ Module operates through a series of intricate steps, each leveraging AI technology for transforming images into dynamic video content:
Subject and Context Identification (904A): The module identifies the subjects present in the images and understands the context they are set in. This process is crucial for interpreting the image in a way that translates effectively into video format;
Correlation and Association Analysis: The module analyzes the correlations and associations between different elements in the image, such as objects, text, and background. This analysis is pivotal in understanding the relationships and interactions within the image, which is key to creating a cohesive and meaningful video narrative;
Storyboard Generation (906A): Utilizing an AI model, the module generates a storyboard based on the analyzed image. This storyboard outlines the sequence of events or scenes that will be depicted in the video, ensuring a logical and engaging flow that is rooted in the content of the original image 906A;
Video Generation (908A): Finally, the module generates the video based on the storyboard using the AI Director Bot Module. This step involves translating the storyboard into a full-fledged video, complete with motion, transitions, and potentially additional elements like audio, to produce a coherent and captivating visual experience 908 A;

FIG. 9B introduces a flowchart of the Sketch Interface Module, envisioned in various embodiments of the invention. This module is designed to interact with user-provided sketches to generate video content.

The Sketch Interface Module operates through a sequence of steps, each utilizing AI technology to transform sketches into videos:
Sketch Image Scanning (902B): The process begins with the module scanning sketch images provided by the user. This step involves analyzing the sketch to identify its fundamental elements, which sets the stage for subsequent processing 902 B;
Applying Ai model Identifying subjects, context of image 904 B;
Using AI model Generating and sending text or image reaction to the user based on identification of subject of context 906B;
Generating story board based on the image/text interaction with user video template based on the story board 908B;
Generating video based on the story board using Ai director bot module 910B;
The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may wherever suitably operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g., digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for generating video, implemented by one or more processors operatively coupled to a non-transitory computer readable storage device, on which are stored modules of instruction code that when executed cause the one or more processors to perform the steps of:
receive entity instructions by text or voice using natural language;
analyzing entity instructions for identifying technical and creative requirements including: style, context and/or content, type and properties of content objects, layout of video frames, order—sequence of disapplying content and/or functionality of objects;
selecting at least one video template of at least one scene based analysed instructions and all identified technical and creative requirements;
exploring and aggregating content of text, image or video multimedia based on identified technical and creative requirements of the selected at least one template;
generating new video by implementing selected or new video template using aggregated content wherein the generated video complies with all analyzed requirements.

2. The method of claim 1 further comprising the steps of:
Generating multiple videos which implement selected or new video template using aggregating content wherein the generated video complies with all analyzed requirements, wherein each video use different template or using different content or properties of objects;
enabling entity to select one of the videos, saving entity history choice
learning personalized entity preferences;
creating Ai model by learning plurality of user's choice, training video editing rules.

3. The method of claim 1 further comprising the step of: exploring and aggregating content from different internal and/or external sources content of text, image or video multimedia based on identified technical and creative requirements.

4. The method of claim 1 wherein all scene media parts are customized and personalized based entity branding/profile data, the branding can be provided by the entity.

5. The method of claim 1 further comprising the step of: entity entering more instruction/editing previous instruction, wherein the entity can select manually more relevant media or use services entity can upload his own media or text Entity can delete scenes, update the script.

6. The method of claim 1 further comprising the step of: enabling entity to approve final version and enabling manual editing of the video.

7. The method of claim 1 further comprising the step of: determining script and style, length of video by a designated AI model based on entity text using external AI system and entity/company profile and branding.

8. The method of claim 1 further comprising the step of: defining scenario parts/scene based on created determined script.

9. The method of claim 1 further comprising the step of: selecting multiple block template of different scenes.

10. The method of claim 1 further comprising the step of: generating content using designated AI model by determining context and/or content, emotion, theme number, type and properties of content objects, layout of video frames, order, sequence of disapplying content, functionality of objects.

11. The method of claim 1 wherein the entity or entity defines length of video wherein the defined length affects the selection of subjects based on priority, the focus in each subject and selection content for each subject to meet the time limit.

12. The method of claim 1 wherein the function of the object is call to action including: hyperlink of communication network, payment or purchase button.

13. A system for generating video, implemented by one or more processors operatively coupled to a non-transitory computer readable storage device, on which are stored modules processors to perform the steps of:
user interfaces module configured to receive user or entity instructions by text or voice using natural language;
video generation server configures for:
analyzing entity instructions for identifying technical and creative requirements including: style, context and/or content, type and properties of content objects, layout of video frames, order sequence of disapplying content, functionality of objects;
selecting at least one video template of at least one scene based analysed instructions and all identified technical and creative requirements;
exploring and aggregating content of text, image or video multimedia based on identified technical and creative requirements of the selected at least one template;
Generating new video by implementing selected or new video template using aggregated content wherein the generated video complies with all analyzed requirements.

14. The system of claim 13 wherein the video generation server the further configured to explore and aggregate content from different internal and/or external sources content of text, image or video multimedia based on identified technical and creative requirements.

15. The system of claim 13, wherein all scene media parts are customized and personalized based entity or entity branding/profile data, the branding can be provided by entity or by smart analyzing any entity content.

16. The system of claim 13 wherein the user interface module is further configured to enable entity entering more instruction/editing previous instruction, enabling to select manually more relevant media or use external services enabling to upload media or text or delete scenes or update the script.

17. The system of claim 13 wherein the user interface module is further configured user approving final version and enabling manual editing option.

18. The system of claim 13 where the video generation server the further configured to determine script or story board, define style by a designated AI model based on user text using external AI system and user/company profile and branding.

19. The system of claim 13 wherein the video generation server the further configured to define scenario parts or scene based on created determined script or user text.

20. The system of claim 13 wherein the video generation server the further configured to select multiple block template of different scene.

21. The system of claim 13 wherein the user or entity defines length of video, wherein the defined length affects the selection of subjects based on priority, the focus in each subject and selection content for each subject to meet the time limit.

22. The system of claim 13 wherein the function of the object is call to action including: hyperlink of communication network, payment or purchase button.
